(19) United States
(12) Patent Application Publication
(10) Pub. No.: US 2006/0282845 A1
(43) Pub. Date: Dec. 14, 2006

(54) Disc cartridge

(75) Inventors: Kenji Hashizume, Tokyo (JP); Akio Momoi, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/447,083

(22) Filed: Jun. 6, 2006

(30) Foreign Application Priority Data
Jun. 9, 2005 (JP) 2005-169261

(51) Int. Cl. G11B 23/03

(52) U.S. Cl. 720/725

(57) ABSTRACT

A disc cartridge comprises: a cartridge body including an upper shell and a lower shell at least one of which is provided with an opening for allowing disc access; a disc tray that is formed to allow a disc-like recording medium to be placed thereon and is arranged in the cartridge body to be rotatable; a pair of shutter members each including a shaft-receiving hole to which a supporting shaft formed in the disc tray is to be inserted, an annular surrounding portion that surrounds the shaft-receiving hole, and a blade portion formed integrally with the surrounding portion outside the surrounding portion, the pair of shutter members being supported by the disc tray to be rotatable and being capable of opening and closing the opening of the cartridge body, each of a pair of shutter members is a member formed by injection molding and has a plurality of gate marks caused by injection molding, one of the gate marks is formed in a surrounding portion of the shutter member and another one of the gate marks is formed in a blade portion of the shutter member.

### BACKGROUND OF THE INVENTION

1. Field of the Invention

The present invention relates to a disc cartridge that is configured to allow an access to a disc-like recording medium accommodated in a cartridge body.

2. Description of the Related Art

Conventionally, as an example of the aforementioned type of disc cartridge, a disc cartridge is widely known that includes: a cartridge body having an upper shell and a lower shell at least one of which has an opening for allowing disc access; a disc tray that is formed to allow a disc-like recording medium to be placed thereon and is provided in the cartridge body to be rotatable; and a pair of shutter members that are pivoted by the disc tray to be rotatable and can open and close the opening of the cartridge body (see Japanese Patent Laid-Open Publication No. 2003-123426, for example).

FIG. 10 shows an exemplary shutter member applied to this type of disc cartridge that is conventionally known. FIG. 10 is a schematic plan view of the shutter member in which a part of the shutter member is omitted.

As shown in FIG. 10, the shutter member 100 includes a shaft-receiving hole 106 into which a supporting shaft of a disc tray (not shown) can be inserted. The shutter member 100 is rotatable with respect to the disc tray around the shaft-receiving hole 106.

However, when the shutter member 100 described above is formed by injection molding, a kind of molding defect called as a weld line may occur around the shaft-receiving hole 106 in a radial direction because of solidification of melted resins that spread around a mold for molding the shaft-receiving hole 106 before being blended with each other. Therefore, the strength around the shaft-receiving hole 106 is lowered in the conventional shutter member 100. This may cause a crack or break around the shaft-receiving hole 106, especially along the weld line when an impact is applied due to fall.

### SUMMARY OF THE INVENTION

In view of the foregoing problems, various exemplary embodiments of this invention provide a disc cartridge that can improve the durability of a shutter member as compared with a conventional shutter member.

The inventor of the present invention found, as a result of earnest studies, a disc cartridge that could improve the durability of a shutter member as compared with a conventional shutter member.

(1) A disc cartridge comprising: a cartridge body including an upper shell and a lower shell at least one of which is provided with an opening for allowing disc access; a disc tray that is formed to allow a disc-like recording medium to be placed thereon and is arranged in the cartridge body to be rotatable; and a pair of shutter members each including a shaft-receiving hole to which a supporting shaft formed in the disc tray is to be inserted, an annular surrounding portion that surrounds the shaft-receiving hole, and a blade portion formed integrally with the surrounding portion outside the surrounding portion, the pair of shutter members being supported by the disc tray to be rotatable and being capable of opening and closing the opening of the cartridge body, wherein each of the pair of shutter members is a member formed by injection molding and has a plurality of gate marks caused by injection molding, one of the plurality of gate marks is formed near the surrounding portion, and at least another one of the plurality of gate marks is formed in the blade portion.

(2) A disc cartridge comprising: a cartridge body including an upper shell and a lower shell at least one of which is provided with an opening for allowing disc access; a disc tray that is formed to allow a disc-like recording medium to be placed thereon and is arranged in the cartridge body to be rotatable; and a pair of shutter members each including a shaft-receiving hole to which a supporting shaft formed in the disc tray is to be inserted, an annular surrounding portion that surrounds the shaft-receiving hole, and a blade portion formed integrally with the surrounding portion outside the surrounding portion, the pair of shutter members being supported by the disc tray to be rotatable and being capable of opening and closing the opening of the cartridge body, wherein each of the pair of shutter members is a member formed by injection molding and has a weld line which is caused by injection molding and located in the blade portion.

According to the disc cartridge of the present invention, an advantageous effect that the durability of a shutter member can be improved as compared with a conventional shutter member can be obtained.

### BRIEF DESCRIPTION OF THE DRAWINGS

FIG. 1 is a perspective view showing an appearance of a disc cartridge according to Exemplary Embodiment 1 of the present invention;

FIG. 2 is a schematic side cross-sectional view of the disc cartridge, taken along the line II-II in FIG. 1;

FIG. 3 is a schematic plan view of a lower shell of the disc cartridge of Exemplary Embodiment 1, seen from the inside;

FIG. 4 is a schematic plan view of an upper shell of the disc cartridge of Exemplary Embodiment 1, seen from the inside;

FIG. 5 is a schematic plan view of a disc tray of the disc cartridge of Exemplary Embodiment 1, seen from a lower shell side;

FIG. 6 is a schematic plan view of the disc tray of the disc cartridge of Exemplary Embodiment 1, seen from an upper shell side;

FIG. 7 is a partial enlarged schematic view of the disc tray of the disc cartridge of Exemplary Embodiment 1;

FIG. 8 is a schematic plan view of a shutter member of the disc cartridge of Exemplary Embodiment 1, seen from the lower shell side;

FIG. 9 is an enlarged schematic view of a portion of the shutter member around a cam groove; and

FIG. 10 is a partial cross-sectional side view showing a state where a supporting shaft of the disc tray is inserted into a shaft-receiving hole of the shutter member.

### DETAILED DESCRIPTION OF THE PREFERRED EMBODIMENTS

A disc cartridge according to the present invention, comprises: a cartridge body including an upper shell and a lower shell at least one of which is provided with an opening for allowing disc access; a disc tray that is formed to allow a disc-like recording medium to be placed thereon and is arranged in the cartridge body to be rotatable; and a pair of shutter members each including a shaft-receiving hole to which a supporting shaft formed in the disc tray is to be inserted, an annular surrounding portion that surrounds the shaft-receiving hole, and a blade portion formed integrally with the surrounding portion outside the surrounding portion, the pair of shutter members being supported by the disc tray to be rotatable and being capable of opening and closing the opening of the cartridge body, wherein each of a pair of shutter members is a member formed by injection molding and has a plurality of gate marks caused by injection molding, wherein one of the gate marks is formed near a surrounding portion and at least another one of the gate marks is formed in a blade portion. Due to this, the durability of a shutter member can be improved as compared with a conventional shutter member.

Moreover, a disc cartridge of the present invention, comprises: a cartridge body including an upper shell and a lower shell at least one of which is provided with an opening for allowing disc access; a disc tray that is formed to allow a disc-like recording medium to be placed thereon and is arranged in the cartridge body to be rotatable; and a pair of shutter members each including a shaft-receiving hole to which a supporting shaft formed in the disc tray is to be inserted, an annular surrounding portion that surrounds the shaft-receiving hole, and a blade portion formed integrally with the surrounding portion outside the surrounding portion, the pair of shutter members being supported by the disc tray to be rotatable and being capable of opening and closing the opening of the cartridge body, wherein each of the pair of shutter members includes a weld line which is caused by injection molding and located in the blade portion. Due to this, the durability of the shutter member can be improved as compared with the conventional shutter member.

The term “weld line” in the present invention shall refer to a site wherein a kind of molding defect at which, during injection molding, melted resins collide against each other and are solidified and molded before being blended with each other.

Examples of the “disc-like recording medium” of the present invention include various types of optical discs such as a rewritable optical disc, a read-only type optical disc, and a write-once optical disc, as well as a magnetooptical disc and a magnetic disc, for example.

The disc cartridges according to the exemplary embodiments of the present invention will now be described in detail with reference to the drawings.

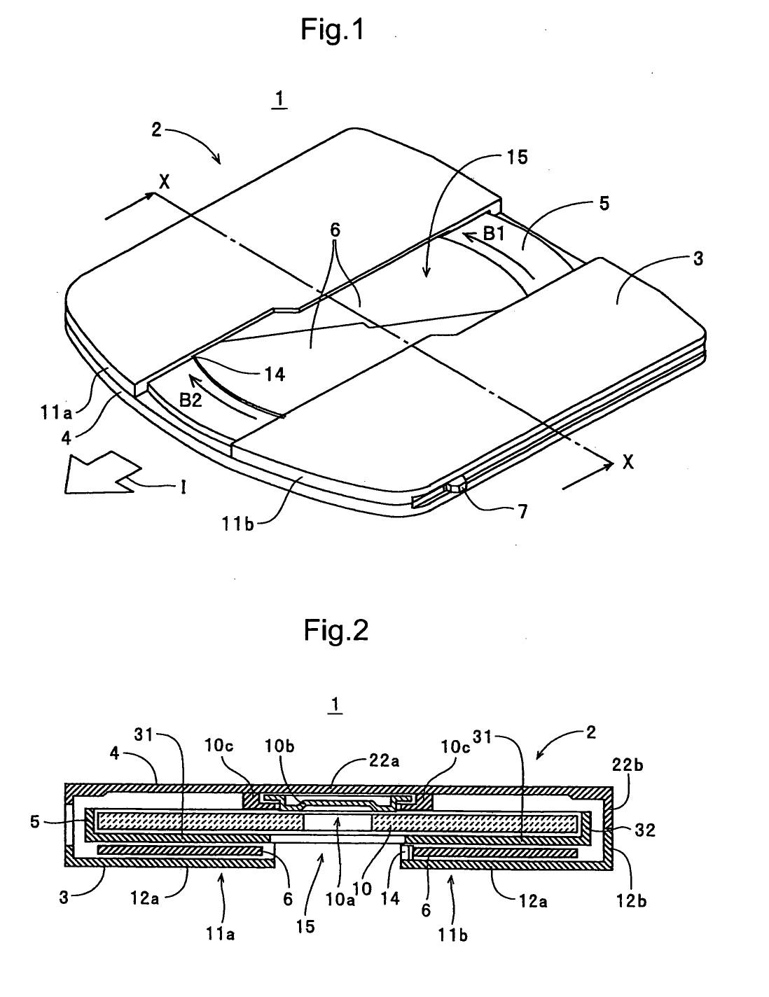

As shown in FIGS. 1 and 2, a disc cartridge 1 according to an exemplary embodiment is configured to include: a cartridge body 2 including a lower shell 3 and an upper shell 4 that can be fitted with each other; a disc tray 5; and a pair of shutter members 6. The disc cartridge 1 is used for a cartridge-type information recording medium configured to allow recording and reproduction of various types of data. Note that FIG. 2 shows the disc cartridge 1 as being larger than its actual size in a thickness direction for facilitating understanding of the present invention.

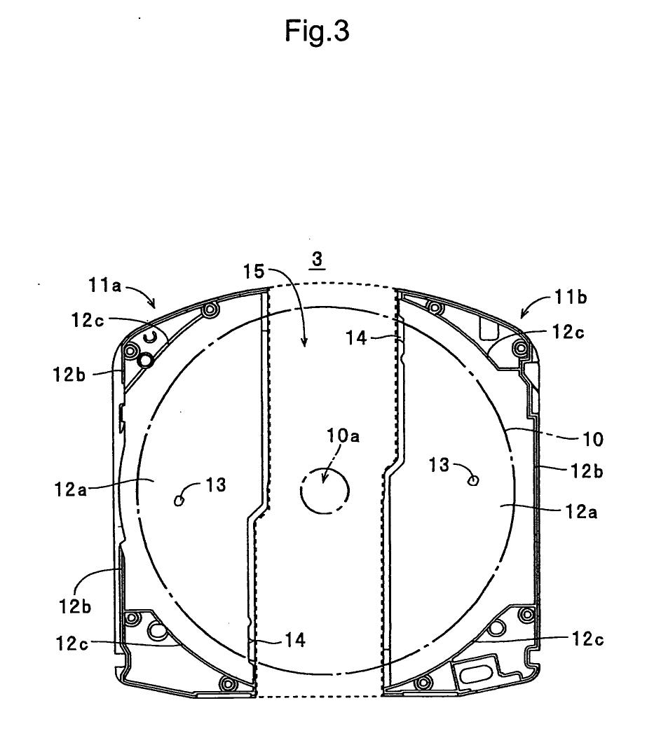

The lower shell 3 of the cartridge body 2 includes a pair of lower shell bodies 11a and 11b, as shown in FIG. 3. The lower shell 3 is formed from polycarbonate (or ABS resin) by injection molding, for example. More specifically, the lower shell 3 (the lower shell bodies 11a and 11b) is configured to include a bottom plate 12a, a sidewall 12b that is provided to stand on an outer peripheral portion of the bottom plate 12a and forms a side face of the cartridge body 2, and a partition 12c that forms a disc accommodating portion in the cartridge body 2. Moreover, the lower shell 3 is configured in such a manner that an opening 15 for disc access is formed between the bottom plates 12a of the lower shell bodies 11a and 11b while the lower shell 3 is fitted with the upper shell 4 (i.e., the upper shell 4 is placed on the lower shell 3 to form one unit). The opening 15 of the present embodiment has a width, a length, and the like that are determined to allow an access (e.g., clamping by means of a recording and reproduction apparatus and irradiation of a laser beam by means of an optical head) to an optical disc 10 in the cartridge body 2 during recording or reproduction of data.

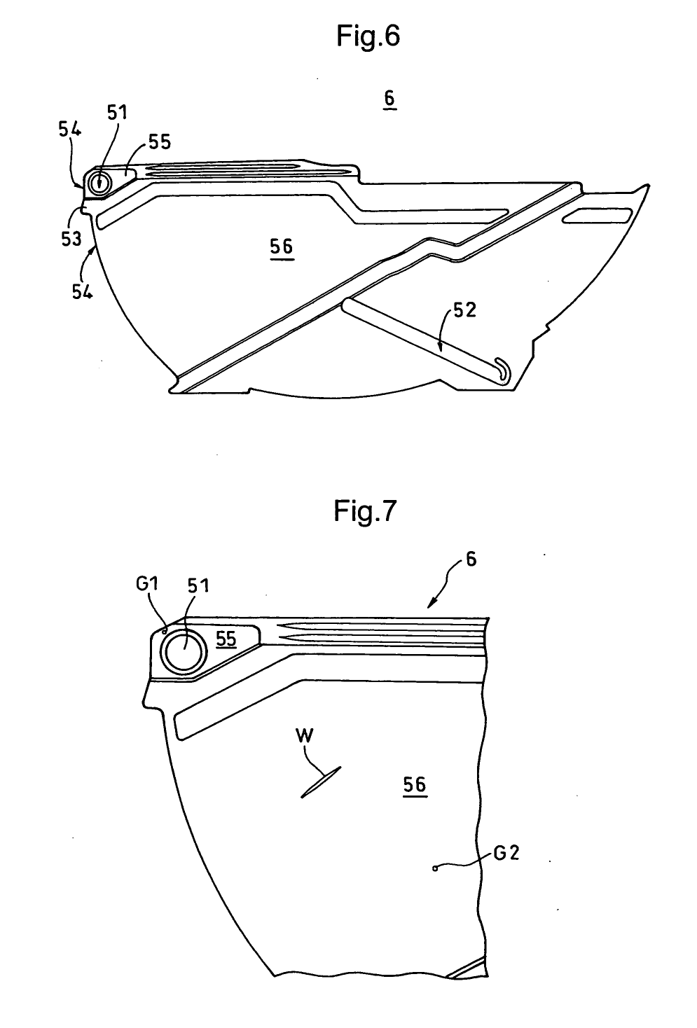

More specifically, the opening 15 is formed in the form of a strip extending from one outer edge of the lower shell 3 (an upper edge in FIG. 3) to another outer edge that is opposed to the above outer edge with a center of the lower shell 3 interposed therebetween (a lower edge in FIG. 3), as shown in FIG. 3. Thus, the opening 15 has a shape and a size that are determined to allow a strip-like region of the optical disc 10 accommodated in the cartridge body 2, which extends between a pair of outer edge regions opposed to each other with a central region around a central hole 10a interposed therebetween, to be exposed to the outside through the opening 15. Due to this structure, the disc cartridge 1 allows recording and reproduction of data for the optical disc 10 by using two optical heads at the same time. Each of the bottom plates 12a of the lower shell bodies 11a and 11b has a convex portion for rotation 13 (hereinafter, referred to as “convex portion”) that is formed to stand. The convex portion 13 is inserted into a cam groove 52 (see FIG. 6) of a shutter member 6 and makes the shutter member 6 slide in accordance with the rotation of the disc tray 5 as described later. Moreover, each of the bottom plates 12a of the lower shell bodies 11a and 11b includes one convex portion 14 formed by making an edge of that bottom plate 12a on the opening 15 side toward the inside of the cartridge body 2.

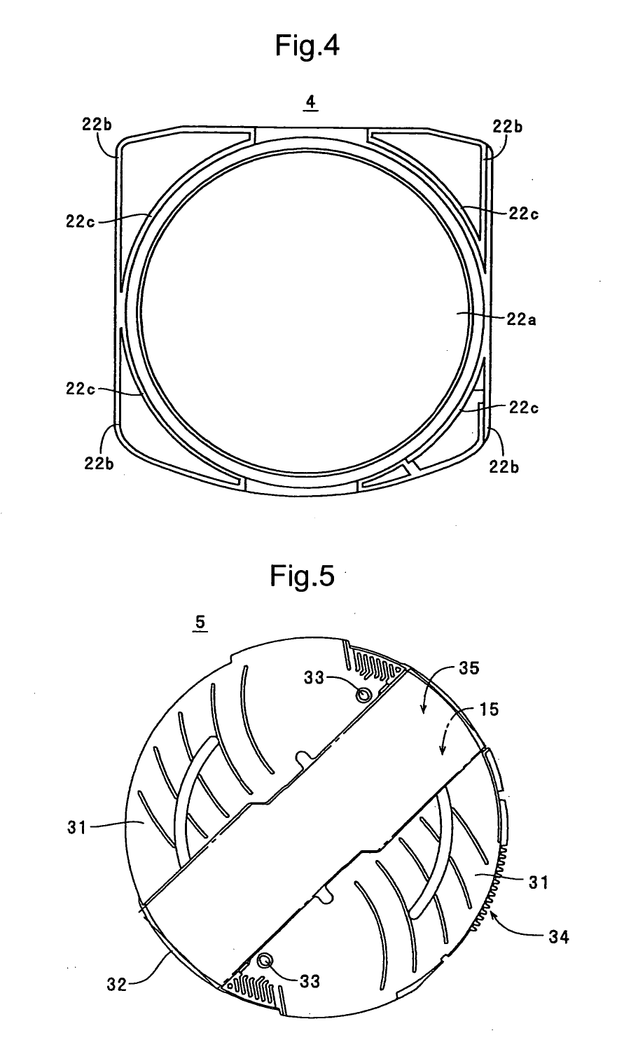

FIG. 4 shows the upper shell 4 of the cartridge body 2 which is configured to include: a top plate 22a; a sidewall 22b that is provided to stand on an outer peripheral portion of the top plate 22a and forms the side face of the cartridge body 2 in combination with the sidewall 12b of the lower shell 3; and a partition 22c that forms the disc accommodating portion in the cartridge body 2 in combination with the partition 12c of the lower shell 3. In the present exemplary embodiment, the upper shell 4 is formed from transparent polycarbonate by injection molding. The upper shell 4 further includes a clamping plate 10b attached to its central portion with a ring-like attachment member 10c, as shown in FIG. 2. In this case, the clamping plate 10b is attached to be rotatable with respect to the upper shell 4 and be slightly movable in a direction in which the clamping plate 10 moves close to and away from the top plate 22a.

In the cartridge body 2, the optical disc 10 is accommodated, as shown in FIG. 2. The optical disc 10 of the present exemplary embodiment is a single-sided rewritable disc-like recording medium, and includes a central hole 10a having a diameter of appropriately 15 mm for allowing a recording and reproduction apparatus (not shown) to clamp the optical disc 10, as shown in FIG. 2. The clamping plate 10b in the form of a circular plate attached to the upper shell 4 is drawn toward the lower shell 3 by means of the recording and reproduction apparatus, thereby the optical disc 10 is clamped by the recording and reproduction apparatus.

As shown in FIG. 5, the disc tray 5 includes a bottom plate 31 in the form of a circular plate with a tray opening 35 formed therein, and a ring-like sidewall 32 that is formed to stand on an outer peripheral portion of the bottom plate 31. The disc tray 5 is configured in the form of a shallow dish on which the optical disc 10 can be placed and is accommodated in the cartridge body 2 together with the optical disc 10 to be rotatable, as shown in FIG. 2. The tray opening 35 is formed to have substantially the same width as that of the opening 15 of the lower shell 3. Note that FIG. 5 shows an opened-side edge of the opening 15 with dashed line.

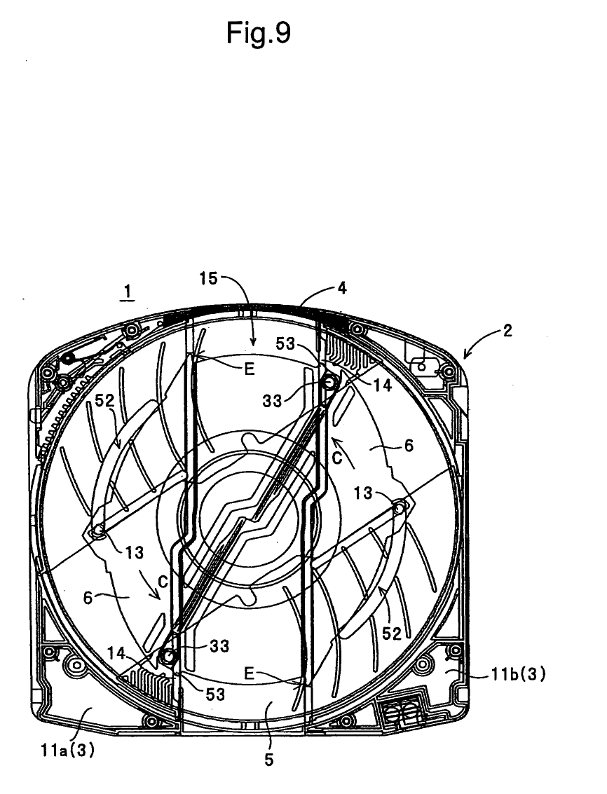

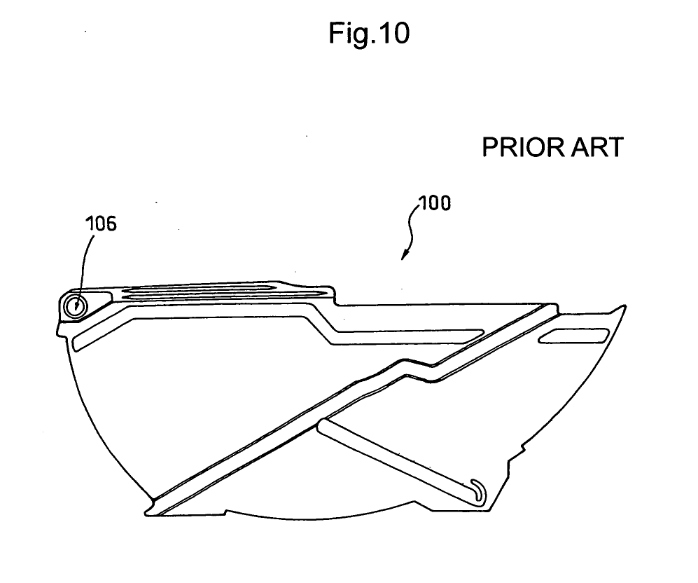

On the lower surface of the bottom plate 31 of the disc tray 5, supporting shafts 33 for supporting the shutter member 6 are formed to stand. As shown in FIG. 9, the supporting shafts 33 support the shutter members 6 near edges of the lower shell bodies 11a and 11b on the opening 15 side at predetermined positions of the disc tray 5, while the disc cartridge 1 is in a restricted state where disc access is restricted. Moreover, the sidewall 32 includes a gear 34 with which a shutter opening and closing mechanism (not shown) of the recording and reproduction apparatus can mesh.

The shutter member 6 is formed by injection molding, and includes: a shaft-receiving hole 51 into which the supporting shaft 33 of the disc tray 5 can be inserted, an annular surrounding portion 55 that surrounds the shaft-receiving hole 51, and a blade portion 56 that is formed integrally with the surrounding portion 55 outside the surrounding portion 55, as shown in FIG. 6. In the present exemplary embodiment, the thickness of the surrounding portion 55 of the shutter member 6 is thinner than that of the blade portion 56 because a gap in a thickness direction has to be formed between the supporting shaft 33 of the disc tray 5 and the surrounding portion 55 of the shutter member 6 in order to smoothly rotate the shutter member 6.

The shutter member 6 has a plurality of (two in this exemplary embodiment) gate marks caused by injection molding, as shown in the enlarged view in FIG. 7. One gate mark G1 is formed in the surrounding portion 55 and another gate mark G2 is formed in the blade portion 56. Moreover, a weld line W caused by injection molding is formed in the blade portion 56.

Returning to FIG. 6, a projection 53 projecting from an outer peripheral edge 54 of the shutter member 6 is formed near the shaft-receiving hole 51. When the disc tray is rotated to be placed in a regulated state, the projection 53 comes into contact with the convex portion 14 prior to the completion of the rotation of the disc tray 5. Furthermore, the projection 53 is configured such that a force pressing the projection 53 against the convex portion 14 gradually becomes larger from the state in which the projection 53 is in contact with the convex portion 14 until completion of the rotation of the disc tray 5. On another end side of the shutter member 6, a slit 52 is formed to which the convex portion 13 of the lower sell 3 can be inserted for guiding the shutter member 6 to a close position where the shutter member 6 closes the opening 15 of the lower shell 3. The shutter member 6 is accommodated in the cartridge body 2 to be sandwiched between the lower shell 3 and the disc tray 5, as shown in FIG. 2, while being supported to be rotatable with respect to the disc tray 5 with the supporting shaft 33 of the disc tray 5 inserted into the shaft-receiving hole 51.

Next, how to use the disc cartridge 1 will be described in detail.

When the disc cartridge 1 is not mounted on a recording and reproduction apparatus, as shown in FIG. 1, the opening 15 of the lower shell 3 is closed by the disc tray 5 and the shutter members 6. Therefore, an access to the optical disc 10 within the cartridge body 2 is regulated. More specifically, regions at both ends of the opening 15 in its longitudinal direction (openings for exposing outer peripheral portions of the optical disc 10) are closed by the bottom plate 31 of the disc tray 5 and a region around the center of the opening 15 in its longitudinal direction (an opening for exposing a portion around the central hole 10a of the optical disc 10) is closed by the shutter members 6. As a result, the opening 15 is entirely closed by the disc tray 5 and the shutter members 6.

When the disc cartridge 1 is used (for performing data recording or reproduction), the disc cartridge 1 is mounted on the recording and reproduction apparatus. In mounting of the disc cartridge 1, when the disc cartridge 1 is inserted and pressed into the recording and reproduction apparatus to some extent, the recording and reproduction apparatus draws the disc cartridge 1 into the inside thereof in a direction shown with arrow I in FIG. 1. Although FIG. 1 shows that the lower shell 3 is faced up, the disc cartridge 1 is mounted in the recording and reproduction apparatus with the upper shell 4 faced up in actual use. In mounting of the disc cartridge 1, the regulation of the rotation of the disc tray 5 by a lock member 7 is lifted when the shutter opening and closing mechanism of the recording and reproduction apparatus comes into contact with the lock member 7.

When the disc cartridge 1 is further drawn into the recording and reproduction apparatus, the shutter opening and closing mechanism meshes with the concave portion 37 and the gear 34 of the disc tray 5. While this state is kept, the disc cartridge 1 is further drawn into the recording and reproduction apparatus, so that the disc tray 5 is rotated with respect to the cartridge body 2 in a direction shown with arrow B1 in FIG. 1. With the rotation of the disc tray 5, the convex portion 13 of the lower shell 3 relatively slides within the cam groove 52 of the shutter member 6. Therefore, the shutter member 6 is rotated with respect to the disc tray 5 around the shaft-receiving hole 51 (i.e., the supporting shaft 33 of the disc tray 5) and is made to slide with respect to the lower shell 3. As a result, the opening 15 of the lower shell 3 is in communication with the tray opening 35 of the disc tray 5 in a thickness direction of the disc cartridge 1 and the shutter members 6 move away from respective positions above the tray opening 35 to allow an access to the optical disc 10 in the cartridge body 2. Then, the clamping plate 10b is magnetically attracted by the recording and reproduction apparatus to clamp a hole edge of the central hole 10a (central region), and thereafter the irradiation of a laser beam through the opening 15 (recording or reproduction of data) is performed.

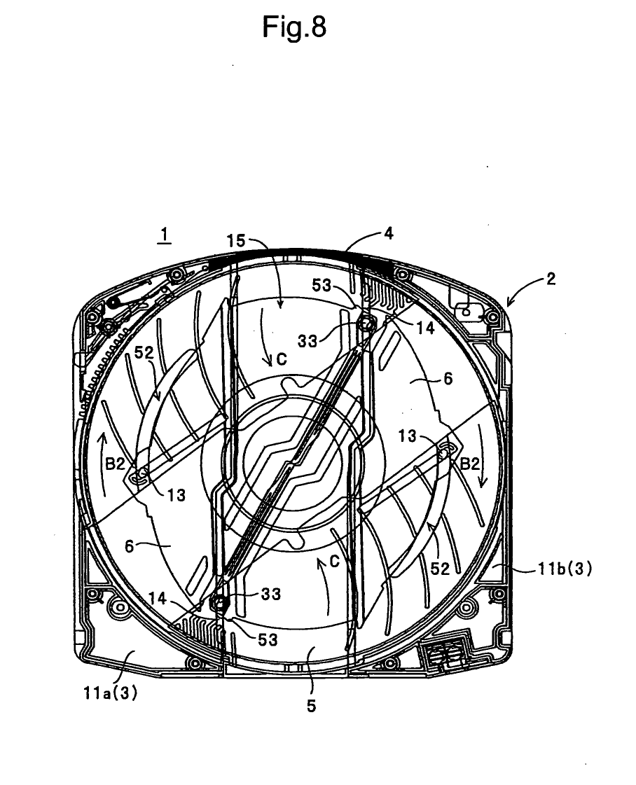

When the disc cartridge 1 for which recording or reproduction of data is finished is removed (ejected) from the recording and reproduction apparatus, the opening 15 of the lower shell 3 is closed by the disc tray 5 and the shutter members 6 and the disc cartridge 1 is placed in the regulated state. More specifically, when the disc cartridge 1 is ejected from the recording and reproduction apparatus, the disc tray 5 is rotated by the shutter opening and closing mechanism in a direction shown with arrow B2 in FIG. 8. With the rotation of the disc tray 5, the shutter members 6 are rotated with respect to the disc tray 5 to slide with respect to the lower shell 3 to the full-close position at which the shutter members 6 close the central region of the opening 15. Finally, the shutter members 6 are in close contact with each other and therefore the opening 15 is completely closed, as shown in FIG. 9.

According to the disc cartridge 1 of the present embodiment, each of a pair of shutter members 6 is a member formed by injection molding and has a plurality of gate marks caused by injection molding. One gate mark G1 is formed near the surrounding portion 55 and another gate mark G2 is formed in the blade portion 56. Thus, it is possible to prevent formation of a weld line around the shaft-receiving hole 51 of the shutter member 6 during injection molding. Therefore, the strength of the shutter member 6 around the shaft-receiving hole 51 can be improved and the durability of the shutter member can be improved than ever before.

Moreover, according to the disc cartridge 1 of the present exemplary embodiment, each of a pair of shutter members 6 is a member formed by injection molding and has the weld line W which is caused by injection molding and located in the blade portion 56. Thus, it is possible to prevent formation of the weld line around the shaft-receiving hole 51 of the shutter member 6 during injection molding. Therefore, the strength of the shutter member 6 around the shaft-receiving hole 51 can be improved and the durability of the shutter member can be improved as compared with a conventional shutter member.

The disc-like recording medium in the present invention is not limited to the rewritable optical disc 10 described in the exemplary embodiment but includes various types of optical discs such as a read-only type optical disc and a write-once type optical disc, as well as a magnetooptical disc and a magnetic disc.

In the exemplary embodiment, an example is described in which the cartridge body 2 includes the lower shell 3 having the separate lower shell bodies 11a and 11b in the disc cartridge 1. However, the present invention can also be applied to a disc cartridge including a cartridge body having a single lower shell like the conventional disc cartridge.

Moreover, the shape of the opening for allowing disc access in the present invention is not limited to a rectangular shape extending forward and backward of the cartridge body 2 as in the above exemplary embodiment, but may be a rectangular shape extending from side to side of the cartridge body or extending along a diagonal in the cartridge body.

Although the opening is formed in the lower shell 3, it is essential only that an opening for allowing an access to a disc-like recording medium is formed at least one of the upper and lower shells.

Furthermore, the number and shape of the gate marks and weld lines that are formed in the shutter member 6 are not limited to those described in the above exemplary embodiment. For example, the shutter member 6 may have three or more gate marks.

What is claimed is:

1. A disc cartridge comprising:
a cartridge body including an upper shell and a lower shell at least one of which is provided with an opening for allowing disc access;
a disc tray that is formed to allow a disc-like recording medium to be placed thereon and is arranged in the cartridge body to be rotatable; and
a pair of shutter members each including a shaft-receiving hole to which a supporting shaft formed in the disc tray is to be inserted, an annular surrounding portion that surrounds the shaft-receiving hole, and a blade portion formed integrally with the surrounding portion outside the surrounding portion, the pair of shutter members being supported by the disc tray to be rotatable and being capable of opening and closing the opening of the cartridge body, wherein
each of the pair of shutter members is a member formed by injection molding and has a plurality of gate marks caused by injection molding, one of the plurality of gate marks is formed near the surrounding portion, and at least another one of the plurality of gate marks is formed in the blade portion.

2. A disc cartridge comprising:
a cartridge body including an upper shell and a lower shell at least one of which is provided with an opening for allowing disc access;
a disc tray that is formed to allow a disc-like recording medium to be placed thereon and is arranged in the cartridge body to be rotatable; and
a pair of shutter members each including a shaft-receiving hole to which a supporting shaft formed in the disc tray is to be inserted, an annular surrounding portion that surrounds the shaft-receiving hole, and a blade portion formed integrally with the surrounding portion outside the surrounding portion, the pair of shutter members being supported by the disc tray to be rotatable and being capable of opening and closing the opening of the cartridge body, wherein
each of the pair of shutter members is a member formed by injection molding and has a weld line which is caused by injection molding and located in the blade portion.
